(19) United States
(12) Patent Application Publication
(10) Pub. No.: US 2015/0324787 A1
(43) Pub. Date: Nov. 12, 2015

(54) Policy-Based Control and Augmentation of Cryptocurrencies and Cryptocurrency Security

(71) Applicant: Sequitur Labs, Inc., Issaquah, WA (US)

(72) Inventor: Daniel Schaffner, Seattle, WA (US)

(21) Appl. No.: 14/691,463

(22) Filed: Apr. 20, 2015

Related U.S. Application Data
(60) Provisional application No. 61/990,448, filed on May 8, 2014.

(51) Int. Cl. G06Q 20/36; G06Q 20/06; G06Q 20/38

(52) U.S. Cl. CPC G06Q 20/3674; G06Q 20/3829; G06Q 20/065; G06Q 20/3825

(57) ABSTRACT

A system for policy-based control and augmentation of cryptocurrency security including policy rules that govern transactions that are embedded in the cryptocurrency transmission. The transactions are then adjudicated using the policy-based control system at the endpoint. The invention first secures the private key to the cryptocurrency in a secure hardware module to ensure that ownership is maintained. Then, the system uses a policy-based control subsystem to embed policy information within the cryptocurrency transmission. On receipt, the transmission is decoupled such that the policy information can be implemented resulting in a decision to approve or disapprove the transaction. The system can be used for multiple signatories on a single transaction as well as any other policy requirement desired.

### CROSS-REFERENCE TO RELATED APPLICATIONS

This application is entitled to the benefit of and claims priority to U.S. Provisional Application 61/990,448, filed on May 8, 2014, which is included by reference as if fully set forth herein.

### TECHNICAL FIELD

The present invention relates generally to secure transactions, e-commerce, cryptocurrency, telecommunications, digital communications, computer security, computer technology, and mobile computing.

### BACKGROUND OF THE INVENTION

A cryptographically-based currency has been proposed that provides for payment transactions between parties based on cryptographic proof rather than trust. That particular system is described in the document entitled “Bitcoin: A Peer-to-Peer Electronic Cash System”, by Satoshi Nakamoto, which is available for internet download as of Apr. 27, 2014 at https://bitcoin.org/bitcoin.pdf. For the system as described therein, an “electronic coin” is defined to be a chain of digital signatures. Such electronic coins can be transferred by one owner to another (the transfer being a payment transaction) via the present owner digitally signing a hash of the previous transaction and the public key of the next owner, and adding the result to the end of the coin. At any given time, a coin is owned by the party or entity possessing the private key associated with the public key at the end of the coin at that time. A payee can verify the signatures to verify the chain of ownership.

The described system includes the use of a distributed peer-to-peer time stamp server to prevent double spending, the time stamp providing robust proof of the order of transactions, especially of the singularity of the present transaction by the immediately previous owner, Privacy can be maintained in such a system partly through the use of new key pairs for each transaction so that multiple transactions cannot be traced to a common owner.

Such systems are said to have significant advantages over earlier forms of payment and online payments such as the elimination of the need for, and likely expense of, a trusted third party to oversee the transaction. From henceforth in the present document we will refer to a cryptographic current or cryptographically-based currency based on such a system, or based on a similar system for payment transactions or other transactions, a “cryptocurrency”, with plural “cryptocurrencies”.

### SUMMARY OF THE INVENTION

Cryptocurrency systems are advantageous because they facilitate electronic transactions without the need for currency or for a trusted third party, however they lack flexibility. Current cyptocurrency systems concern themselves only with the verification of the currency itself, not with the transaction the currency is to be used for. The present invention addresses this shortcoming by inserting a policy-based system at the endpoints of each transaction with the ability to embed policy concerning the transaction into the coin itself that is transmitted from endpoint to endpoint. The system can be used for simple, point to point transactions with one buyer and one seller, or it can be used for more complex transactions where multiple approvals might be needed. Furthermore, the policy system is extensible such that any parameter can be used as part of the approval process to include, time of transaction, place of transaction, context of the sale, or approved vendor.

### BRIEF DESCRIPTION OF THE DRAWINGS

FIG. 1 shows the cryptocurrency wallet secured with secure hardware private key storage. The owner of the wallet can view the wallet externally but cannot access the key to the cryptocurrency cy without having the private key that can optionally be secured by a separate access key.

FIG. 2 shows a schematic representation of the policy-based access control system.

FIG. 3 shows a sender(initiator of a transaction) using the policy control system to embed policy in the coin transmission to the receiver. There, the policy is implemented and the transaction is adjudicated resulting in execution or rejection of the transaction.

FIG. 4 shows the policy-controlled cloud-based wallet for cryptocurrency. The originator initiates a transaction that must be verified by a secondary key according to the policy. The receiver implements the policy to verify that both keys are present before approving the transaction.

### DESCRIPTION OF THE INVENTION

The invention consists of a system and methods for augmenting and supplementing cryptocurrencies, to manage the use of such currencies, provide customizable governance of payment transactions, provide new features for improving cryptocurrency utility, and to enhance the security of cryptocurrencies.

The system is used to secure cryptocurrency ownership to assure that the keys to the currency are under the control of the rightful owner, A given user or owning entity's electronic coins can be accessed and used via digital “wallets” that contain linkages of specific coins to that owner's private key(s) that represent coin ownership. Here, a “wallet” may be any user space application or software or hardware entity that has such linkages to the owners private keys or otherwise manages the set of owned coins for the owner. It is the private key ownership that is desired by owners to be as secure as possible, since unauthorized access to the private key(s) associated with an electronic coin exposes the coin to potential theft and other unauthorized uses.

One approach to defending security-related systems and components from malicious attack is to have all or part of them reside within especially secure areas, partitions, or environments on device hardware that are inaccessible to unauthorized parties and/or for unauthorized purposes, and are separated from the main device operating system, file system, and, in some cases, from certain of its resources. A further degree of security can be provided if such secure partitions or areas are also invisible and undetectable to the greatest degrees possible, under unauthorized circumstances and by unauthorized parties.

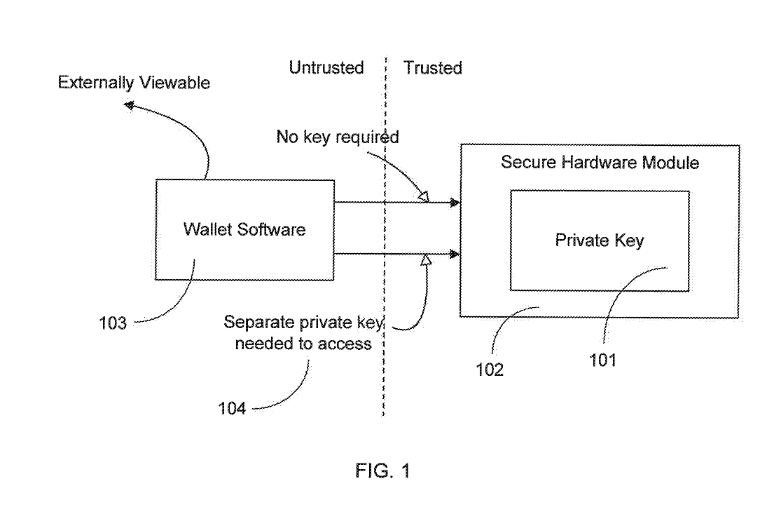

The present invention therefore places the private keys (101) of electronic coin wallets in such secure areas (102) on computing devices, or on secure removable media. The wallets themselves (103), having a need for user viewing and input, can reside in less secure areas, but having carefully limited access to the private keys held in secure storage for use in authorized wallet viewing and authorized transactions. Such access itself may separately be secured by a requirement to have possession of a separate private key (104) that secures the containing hardware and private key file storage area for the owned coins associated with the wallet. This is represented in FIG. 1.

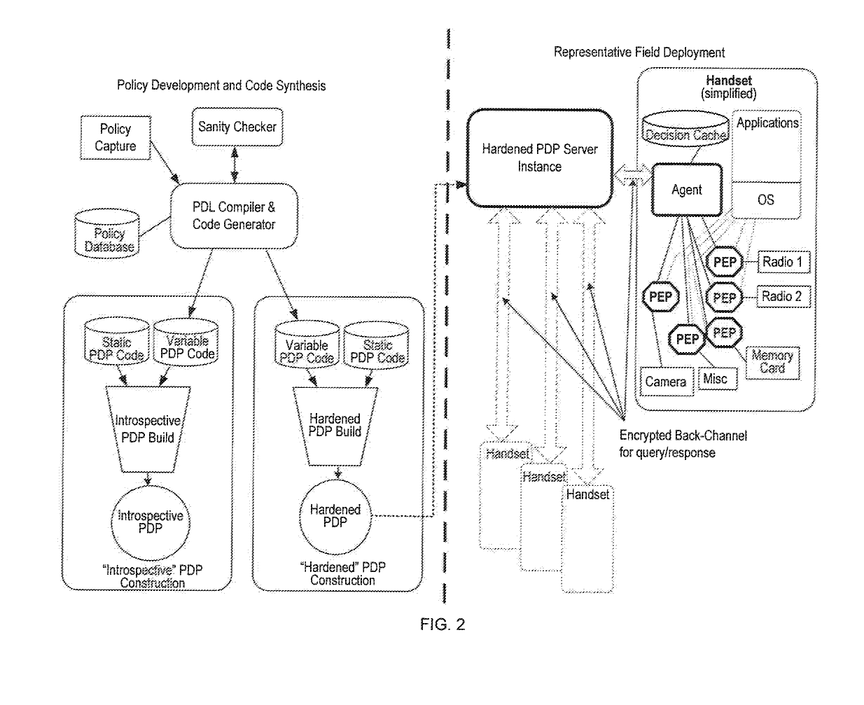

U.S. patent application Ser. No. 13/945,677, included by reference as if fully set forth herein, discloses a system for policy-based. access control and management for mobile computing devices, The basic system presented in that application is depicted in FIG. 2, The system described therein provides extensive granularity of control over permitted operations, plus network, file system, and device access on devices controlled by the system. Furthermore, the system utilizes one or more policy decision point (PDP) servers which respond to encrypted queries from computing devices controlled by a given instance of the system. These PDP servers may be remote from the computing device, or may even be hosted within the computing device. The queries typically encapsulate requests for use of specific device or network-accessible assets, and the PDP response to such a request is then received by the querying device, with subsequent decisions made by the PDP then enforced at the Policy Enforcement Points (PEPs) on the device. Such a secure policy-based system can be used to augment and enhance a cryptocurrency system in the following ways.

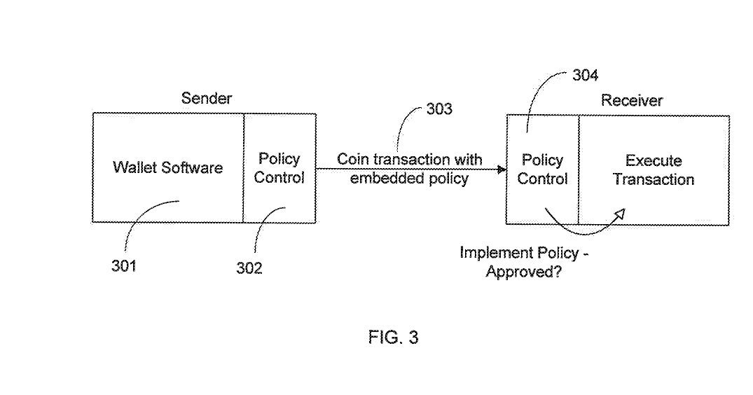

First, the cryptocurrency system and protocol can be extended to embed policy within it (see FIG. 3). A given wallet application of a user (301) or a supplementary application could be used to specify one or more payment policies (302), and then the policy could be signed and embedded in a given payment transaction of an electronic coin (303), with said policy or policies being held by the cryptocurreney network or system. The policies can be embedded by compiling them into the electronic coin, appended to the electronic coin, or encrypted with the electronic coin. Then, a given payment could only be sent if the policy or set of policies was successfully implemented. The policy set becomes an enforcement requirement for payment (304). In this manner, the embedded policy also adds complexity and desirable processor node work items to the cryptocurrency system.

As non-limiting examples, policies could specify that a given coin could only be used for the purchase of office supplies or other specific items, or that only specific vendors may be purchased from, or that only approved nontoxic materials may be purchased with the coin. Policies may also be enforced wallet-wide by reproduction of policy elements across all coins in the wallet at purchase time.

Second, a network with policy built or compiled into it could have event-driven protections native to the network itself. These inherent protections might make it possible to effectively manage a widely disparate, peer-to-peer network. For a cryptocurrency network, such embedded policy can provide additional security controls, for example, in the form of policies that limit or halt transactions, or notify appropriate administrative parties, if transaction frequencies from a specific party exceed some specified threshold at which suspicion of undesired activity is warranted.

Third, cryptocurrencies can include requirements for multiple signatures by more than one private key for a given payment to proceed. This is described here http://bitcoin.stackexchange.com/questions/3718/what-are-multi-signature-transactions. This allows for many useful payment control scenarios, such as that of an organization providing payment only if a majority of key-holders within it accede to the payment, or only if two or more authorized personnel sign the payment.

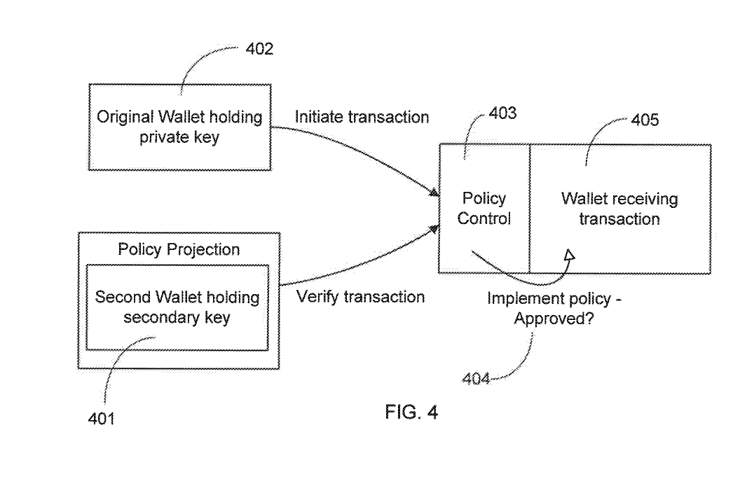

In the present invention, this concept is extended to include all aspects of policy, not only multiple signatories. A policy-based system provides extensive policies for novel, complex multi-signature requirements that lead to new possibilities. For one such case, a policy-protected “cloud-based wallet” is shown in FIG. 4. In one implementation of such a cloud-based wallet, the wallet protects an additional required signature (401) beyond one assigned by the user's locally held key (402). The user and/or other authorized parties would define their policies (including contextual data) for the use of that additional signature, and that policy (403) would determine whether or not the additional key would sign off on the requested transaction (404) and hence allow it to proceed (405).

### INDUSTRIAL APPLICATION

The invention applies most generally to commerce, particularly e-commerce, but can be further generalized to any application domain where transactions are to be governed by policy rules. The invention relies on the existence of a cryptocurrency system such as, but not exclusive to Bitcoin. The system describe herein would be utilized at the endpoints of transactions where policy can be implemented and enforced. It further operates not only on single, point to point transactions, but when multiple users are involved in the transaction or over an entire network to enforce consistency in policy execution.

### CITATION LIST

Nakamoto, Satoshi. “Bitcoin: A peer-to-peer electronic cash system.” Consulted 1.2012 (2008): 28. Obtained from http://www.cryptovest.co.uk/resources/Bitcoin%20paper%20Original.pdf on Apr. 6, 2015.
Bitcoin, Inc., “What are multi-signature transactions?”, Obtained from http://bitcoin.stackexchange.com/questions/3718/what-are-multi-signature-transactions on Apr. 6, 2015.

What is claimed is:

1. A system for policy-based control of secure transactions using cryptocurrency electronic coins for payment, said system comprising:
a digital wallet application for linking to electronic coins;
a private key for obtaining access to electronic coins;
an embedding subsystem for embedding policy information relevant to a transaction into one of said electronic coins;
a transmission subsystem for transmitting electronic coins with embedded policy information;
a decoupling subsystem for separating electronic coins from the embedded policy information; and
a policy management subsystem for validating the transaction based on the embedded policy information.

2. The system of claim 1 wherein the private key for accessing the electronic coins is held in a secure hardware module that requires one or more separate private keys to obtain access to the secure hardware module.

3. The system of claim 1 wherein the private key for accessing the electronic coins is held in a secure removable media that requires one or more separate private keys to obtain access to the secure removable media.

4. The system of claim 1 wherein the digital wallet application includes one or more payment policies specific to a transaction.

5. The system of claim 1 wherein the embedding subsystem further includes at least one of the following subsystems:
a compiling subsystem for compiling policy information into electronic coins;
an appending subsystem for appending policy information to electronic coins; and
an encryption subsystem for encrypting policy information and one of said electronic coins into a single encrypted file.

6. The system of claim 1 wherein the policy management subsystem requires a digital signature from the originating user to validate the transaction.

7. The system of claim 6 wherein the policy management subsystem further requires one or more additional digital signatures in addition to that of the originating user to validate the transaction.

8. A method for policy-based control of cryptocurrency electronic coin secure transactions comprising the steps of:
linking electronic coins to a digital wallet application;
accessing electronic coins via, a private key;
embedding policy information relevant to a transaction into a payment transaction in an electronic coin;
transmitting the electronic coin with embedded policy information;
receiving the electronic coin with embedded policy information;
decoupling the embedded policy information from the electronic coin; and
validating the transaction based on the policy information.

9. The method of claim 8 wherein the electronic coins are accessed within a secure hardware module using a private key.

10. The method of claim 8 wherein the electronic coins are accessed within a secure removable media device using a private key.

11. The method of claim 8 wherein the private key is accessible only via one or more separate private keys.

12. The method of claim 8 wherein the policy information is embedded into the electronic coin further including at least one of the following steps:
compiling the policy information into the electronic coin;
appending the policy information to the electronic coin; and
encrypting the policy information with the electronic coin.

13. The method of claim 8 wherein the validation of the transaction is based on policy information that includes:
a digital signature from the originating user;
a set of permitted or disallowed vendors;
a maximum or minimum transaction amount;
a maximum transaction frequency;
a set of allowed or disallowed transaction locations;
a set of allowed or disallowed purchase items; and
an allowed or disallowed time period for the transaction.

14. The method of claim 13 wherein one or more of the policies requires at least one digital signature for validation of a transaction in addition to the digital signature of the originating user.
